(19) United States
(12) Patent Application Publication
(10) Pub. No.: US 2010/0228623 A1
(43) Pub. Date: Sep. 9, 2010

(54) TRACKING AD UNIT PERFORMANCE

(75) Inventors: CHRISTO DEVARAJ, Seattle, WA (US); BRETT MORIEN, Redmond, WA (US); MICHAEL LUTHER, Issaquah, WA (US); RISHI BAL, Bellevue, WA (US); MATTHEW FORD, Redmond, WA (US); SARANATH ARAVAMUDHAN, Redmond, WA (US); YANLIN HUANG, Sammamish, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/400,620

(22) Filed: Mar. 9, 2009

(51) Int. Cl. G06Q 30/00; G06Q 90/00

(52) U.S. Cl. 705/14.45

(57) ABSTRACT

Methods and computer storage media for tracking and reporting ad unit performance are described. Tags are associated with ad units and may be manually associated and/or extracted from content items to be presented on a webpage associated with an ad unit. Upon receipt of a request for an advertisement to be presented in association with an ad unit, one or more associated tags are also received. Performance of the ad unit may be tracked utilizing the associated tags and one or more performance data elements, for instance, click-through-rate, income generated by the ad unit, visitor data, number of impressions, and expected cost per thousand impressions (eCPM). Reports on the tracked performance may be generated as desired.

### BACKGROUND

The use of advertisements on the World Wide Web is abundant. The ability to track the performance of such advertisements with respect to characteristics such as impressions, click-through-rate, income generated, and user demographics is helpful to both advertisers and publishers of web pages having advertisements associated therewith. Advertisers may use performance data to identify effective advertisements and to target advertising campaigns. Publishers may use such data to determine advertisements and webpage content that generate the greatest income.

### SUMMARY

Embodiments of the invention generally relate to using descriptive tags associated with ad units for tracking and reporting on the performance thereof. Such descriptive tags may be manually associated with an ad unit and/or extracted from a content item, e.g., an article, presented in association with a webpage. Thus, as utilized herein, a “tag” refers to metadata that is descriptive of a characteristic, property, or category of an ad unit (for instance, “rectangular shape,” “rounded corners,” “recipes,” “football,” “NFL,” or the like) or a content item to be presented on the webpage associated with the ad unit. An ad unit is a location or portion of a webpage that is reserved for placement of advertisements therein. In accordance with embodiments hereof, upon loading of a webpage for viewing by a user, a request for an advertisement is sent to an advertisement network (ad network) requesting return of at least one advertisement to occupy any ad units associated with the webpage. With the advertisement request, any tags associated with the ad unit are also transmitted. The ad network not only returns the requested advertisement(s) but also records the associated tag(s) and tracks the performance of the ad unit utilizing the tag(s). Reports on the ad unit performance may then be generated, organized, and/or sorted through use of the tags.

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

### BRIEF DESCRIPTION OF THE DRAWINGS

Illustrative embodiments of the invention are described in detail below with reference to the attached drawing figures, wherein:

FIG. 1 is a block diagram of an exemplary computing environment suitable for use in implementing embodiments of the invention;

FIG. 2 is a flow diagram illustrating a computer-implemented method for tracking ad unit performance according to embodiments of the invention;

FIG. 3 is a flow diagram illustrating a computer-implemented method for tracking ad unit performance according to embodiments of the invention;

FIG. 4 is a flow diagram illustrating a method for reporting ad unit performance according to embodiments of the invention; and

FIG. 5 is a flow diagram illustrating a method for tracking ad unit performance, according to embodiments of the invention.

### DETAILED DESCRIPTION

The subject matter of embodiments of the invention is described with specificity herein to meet statutory requirements. However, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among, or between various steps herein disclosed unless and except when the order of individual steps is explicitly described.

Embodiments of the present invention provide methods, systems and computer storage media for tracking and reporting ad unit performance. Tags are associated with ad units and may be manually associated and/or automatically extracted from content items to be presented on a webpage associated with an ad unit. Upon receipt of a request for an advertisement to be presented in association with an ad unit, one or more associated tags are also received. Performance of the ad unit may be tracked utilizing the associated tags and one or more performance data elements, for instance, click-through-rate, income generated by the ad unit, visitor data, number of impressions, and expected cost per thousand impressions (eCPM). Reports on the tracked performance may be generated as desired.

In one embodiment, the present invention provides one or more computer storage media having instructions embodied thereon that when executed by a computing device, perform a method for tracking ad unit performance. The method includes receiving a request for an advertisement to be presented in association with an ad unit, wherein an ad unit comprises a location on a webpage configured for presenting advertisements. The method further comprises receiving one or more tags associated with the advertisement request, determining one or more appropriate advertisements for presentation, and providing the determined one or more appropriate advertisements. If desired, the method may further include recording performance of the ad unit based on the one or more tags utilizing one or more performance data elements, for instance, click-through-rate, income generated by the ad unit, visitor data, a number of impressions, and an eCPM. The method may additionally include generating a report on the ad unit performance utilizing the one or more performance data elements, wherein the generated report includes performance information pertaining to the one or more tags.

In another embodiment, the present invention provides a method for tracking ad unit performance utilizing a computing device. The method includes associating one or more tags with an ad unit utilizing the computing device, wherein the ad unit comprises a location on a webpage for presenting advertisements. The method further comprises transmitting a request for an advertisement to be presented in association with the ad unit, wherein the request includes an identifier for each of the one or more tags. Additionally, the method comprises presenting a returned advertisement in association with the ad unit on a display device coupled with the computing device. If desired, the method may further comprise selectively querying for one or more performance data elements (e.g., click-through-rate, income generated by the ad unit, visitor data, a number of impressions, or an eCPM) for the ad unit based on at least one of the one or more tags associated therewith.

In yet another embodiment, the present invention provides one or more computer storage media having instructions embodied thereon, that when executed by a computing device, perform a method for reporting ad unit performance. The method comprises receiving a request for an advertisement from a webpage having an ad unit associated therewith, wherein the ad unit comprises a location on the webpage for presenting an advertisement. The method further includes receiving one or more tags associated with the received request, providing an appropriate advertisement to be presented in association with the ad unit on the associated webpage, recording performance of the ad unit based upon one or more performance data elements and the one or more tags associated with the received request, receiving a selection of at least one of the one or more tags on which to report on performance utilizing the one or more performance data elements, compiling data related to the selected at least one tag and the one or more performance data elements, and presenting a report of the ad unit performance based upon the selected at least one tag and the one or more performance data elements.

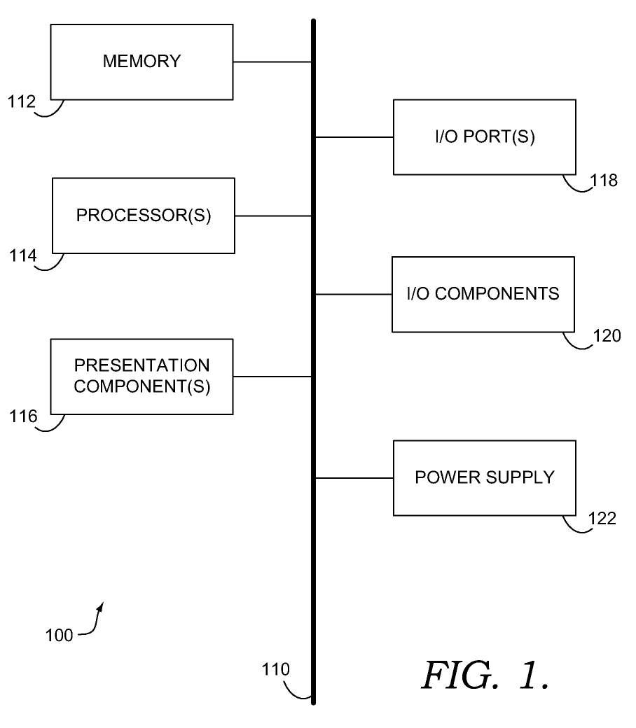

Having briefly described an overview of embodiments of the present invention, an exemplary operating environment in which various aspects of the present invention may be implemented is now described. Referring to the drawings in general, and initially to FIG. 1 in particular, an exemplary operating environment for implementing embodiments of the invention is shown and designated generally as computing device 100. The computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments hereof may also be practiced in distributed computing environments where tasks are performed by remote-processing devices that are linked through a communications network.

With continued reference to FIG. 1, the computing device 100 includes a bus 110 that directly or indirectly couples the following devices: memory 112, one or more processors 114, one or more presentation components 116, input/output ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It is recognized that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; Compact Disc Read Only Memory (CDROM), digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

The memory 112 includes computer-storage media in the form of volatile and/or nonvolatile memory. The memory 112 may be removable, non-removable, or a combination thereof. Exemplary hardware devices include solid-state memory, hard drives, optical-disc drives, etc. The computing device 100 includes one or more processors that read data from various entities such as the memory 112 or I/O components 120. Presentation component(s) 116 present data indications to a user or other device. Exemplary presentation components 116 include a display device, speaker, printing component, vibrating component, etc.

I/O ports 118 allow the computing device 100 to be logically coupled to other devices including I/O components 120, some of which may be built in. Illustrative components include a microphone, joystick, game pad, satellite dish, scanner, printer, wireless device, etc.

As previously set forth, embodiments of the present invention relate to systems and methods that use descriptive tags associated with ad units for tracking and reporting on the performance thereof. Such descriptive tags may be manually associated with an ad unit and/or automatically extracted from a content item, e.g., an article, presented in association with a webpage. Thus, as utilized herein, a “tag” refers to metadata that is descriptive of a characteristic, property or category of an ad unit (for instance, “rectangular shape,” “rounded corners,” “recipes,” “football,” or the like) or a content item to be presented on the webpage associated with the ad unit. In another embodiment, ad units are presented in displays or visualizations of software other than web pages, such as for example and not limitation, software games and user interfaces. The display of ad units with respect to a webpage is described hereinafter for sake of clarity in explanation, but such is not intended to limit the scope of the invention to display of ad units in webpages only. An ad unit is a location or portion of a webpage that is reserved for placement of an advertisement therein. The location is an area on the webpage layout into which an advertisement may be placed. Many options for locating and inserting advertisements into a webpage are available. In embodiments, a single ad unit is occupied by a one or more advertisements, but other configurations are foreseeable, including an ad unit being occupied by zero advertisements.

The performance of an ad unit is measured based on many different characteristics. Some such characteristics include, by way of example only, click-through-rate (CTR) (i.e., the ratio of the number of times an advertisement is clicked by a user versus the number of times the advertisement is displayed to users), impressions (i.e., the number of times the advertisement is presented to and viewed by users), income generated by the ad unit based upon advertisements presented in association therewith, visitor data (e.g., demographic data of users who view the ad), and eCPM (e.g., expected cost per thousand impressions of the ad unit), among other data, metrics and statistics generated there from.

As a placeholder for an advertisement, an ad unit does not, by itself, have or contain an advertisement or ad creative. In order to obtain an advertisement for display, a webpage publisher may register an ad unit with an ad network. An “ad network,” as utilized herein, may comprise any service that provides advertisements for ad units. In an embodiment, an ad network is an aggregator of advertisers and publishers, and may include ad centers, vertical networks, and network aggregators, among other systems. The ad network may provide its own advertisements, or the ad network may be a broker, or aggregator of other's advertisements. In embodiments, an ad network also provides other services such as tracking and reporting on ad unit performance, as more fully described below.

A publisher registers an ad unit with an ad network by indicating to the ad network identifying information for the ad unit, such as for example and not limitation, a name, a location, a color, and a size of the ad unit. The ad network may provide a segment of code or an address which the publisher inserts into the script of the webpage to allow the ad unit to request advertisements from the ad network, or the ad network may make any necessary insertions or annotations to the webpage automatically. Further, the publisher may publish the webpage in any available manner, such as for example on a private server or via a webpage publishing service.

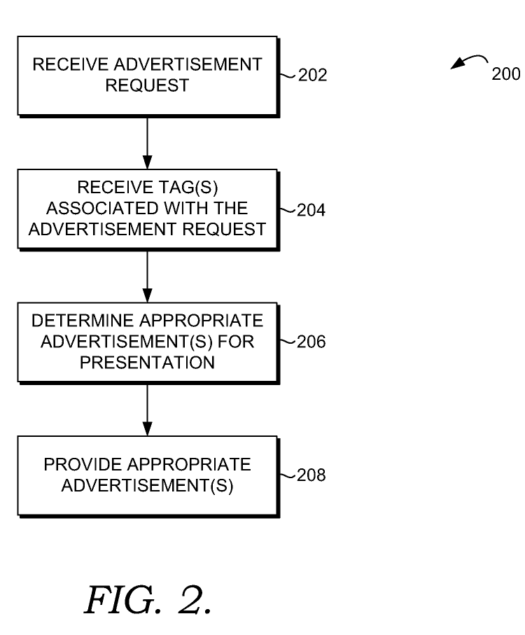

With reference now to FIG. 2, a flow diagram is provided illustrating a computer-implemented method 200 for tracking ad unit performance according to embodiments of the invention. Initially, one or more tags are associated with an ad unit. A tag refers to metadata, or a descriptor that is descriptive of the item that is tagged, in this case, an ad unit. Tags are descriptive of any characteristic of an ad unit including such characteristics as the ad unit's color, size, shape, location, or of a category into which an ad unit falls, such as “sports,” “football,” or “cooking.” Tags may also describe the webpage in which the ad unit is located, content of the webpage, and content of items, for instance, articles, presented in association with the webpage. For example, assume an ad unit is placed along the left hand side of a webpage on a brown background and that the webpage is about cars and has yellow writing. Such an ad unit might have tags like “car,” “automobile,” “brown background,” and “yellow script,” among others. The tags may be associated with an ad unit by inserting the tag information into the script or code for the ad unit or webpage, among other methods.

A request for advertisements from an ad network is made, as indicated at block 202. In embodiments, a user navigates their web browser to the webpage. When the webpage loads, the user's web browser executes the webpage script. The code or address information described above to enable the ad unit to obtain advertisements from the ad network is executed with the webpage script and requests for advertisements are transmitted to the ad network. The ad unit's code also contains the tags, which are transmitted to the ad network with the requests for advertisements, as indicated at block 204. In response to the request, one or more advertisements are determined appropriate for presentation in an ad unit based on the tags, as indicated at 206. The advertisements are provided, as indicated at block 208, are presented in association with the ad unit, for instance, on a display device coupled with a computing device.

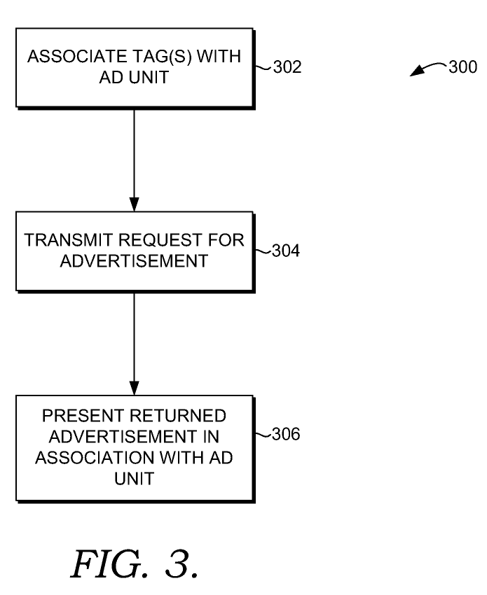

With reference now to FIG. 3, a flow diagram is provided illustrating a computer-implemented method 300 for tracking ad unit performance according to embodiments of the invention. A webpage having one or more ad units and a content item (e.g., an article) is provided by a publisher. The webpage and ad units, as described above, may be any webpage having any number of ad units. An article may include any portion of text on a webpage. In embodiments, a content item is a post to a web log, or blog. A blog is described generally, as a web-based diary or post that may be public or private and has entries on any topic, or topics. A blog may be maintained and provided by a publisher, or the blog content may be maintained by a publisher while the website is provided by a third party provider of blogging resources (hereinafter “blog provider”). A blog may have one or more ad units associated with a webpage on which the blog articles are displayed. The ad units may be configured by a publisher or by a blog provider. Further, a single ad unit may be displayed with each blog post provided by a publisher. For example, in an embodiment, a publisher writes and posts three blog entries on blog provider's website. Each of the three blog entries are presented on separate web pages when viewed by users, but the same ad unit is displayed on each of the three web pages.

One or more tags may be associated with the content item, as indicated at block 302. Tags, as described above, comprise metadata or descriptors about the thing that is tagged, here, the content item. The article's tags describe a category, subject matter, topic, language, font, length, or other characteristic of the article, the webpage in which the article is published, or any other descriptor a publisher wishes to include. In embodiments, a publisher tags an article by providing a list of tags within the article, or associated with the article, such as in a header, footer, title, or other location. In another embodiment, a website, such as a blog provider's website as described above, provides tagging capabilities in which a publisher selects tags from a list of tags, or supplies their own tags via a data entry component of the website. Such a website utilizes the tags to categorize entries, such as blog entries, to aid users in finding and searching articles.

As indicated at block 304, a request for advertisements to occupy one or more ad units on a webpage is transmitted to an ad network as a result of the webpage loading at a user's web browser, as described above. The request for advertisements includes an identifier for each of the one or more tags associated with the content item. The identifier may include the tag itself or any identifier thereof, such as an alpha-numeric value, a category identifier, and the like. Any and all such variations and any combination thereof, are included within the scope of embodiments of the present invention.

In embodiments, the one or more tags are transmitted to the ad network by permitting the ad network to extract the tags from the content item or webpage. The extraction of the tags from the article may include one or more extraction processes depending upon how the article is tagged and where the tags are located with respect to the article and webpage. In an embodiment, the tags are provided in a comma-separated list at the end of the article. An extraction routine from the ad network recognizes the comma separated list and extracts the tags there from. The list may also be separated by other separators, such as spaces, or characters, or may be formatted in any useful format. In another embodiment, the article is a post on a blog and the blog provides a publisher with tagging capabilities, as described above. The blogging provider may provide the tags by methods known by the ad network to enable tag extraction. For example, the blog provider may list the tags in the webpage script, on the webpage near the article, or in the webpage address. In other embodiments, the article may not have tags provided by the publisher, but rather an extraction routine may analyze the article to determine keywords or phrases to use as tags, thereby generating tags automatically. Additionally, the ad network may create a tag for the article based on the address of the webpage on which the article appears.

The ad network identifies an appropriate advertisement for presentation, transmits the advertisement to the webpage and the advertisement is presented in association with the ad unit, as indicated at block 306.

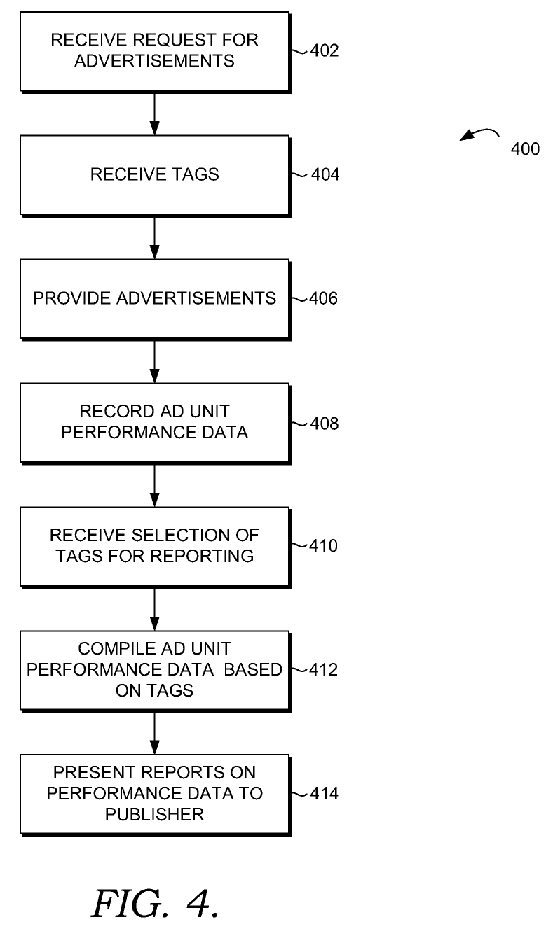

With reference now to FIG. 4, a flow diagram is provided illustrating a method 400 for reporting ad unit performance according to embodiments of the invention. A request for advertisements to fill ad units is received at an ad network, as indicated at block 402. One or more tags are also received with the request for advertisements, as indicated at block 404. One or more advertisements are provided to the webpage, as indicated at block 406. As indicated at block 408, the ad network records ad unit performance data elements by monitoring the performance of the ad units for which advertisements have been supplied. In embodiments, the ad network monitors and records performance data elements such as for example click-through-rates, the number of impressions for the advertisements, and eCPM. In embodiments, the ad network may also record user demographic data and any other data available regarding the interaction of a user, the ad units, and the advertisements placed therein.

As indicated at block 410, a selection of one or more tags for which to report ad unit performance data elements is received from a publisher. In embodiments, an ad network provides a user interface to a publisher for providing services related at least to ad units. A publisher accesses a reporting page of the user interface at which the publisher selects one or more of the tags associated with the publisher's ad units. The ad network compiles ad unit performance data elements based on the selected tags, as indicated at block 412, and presents the data to the publisher, as indicated at block 414. The data may be presented in any available format including tables, graphs, charts, lists, and text.

In an embodiment, assume a publisher has ten ad units registered with the ad network. The registered ad units are each on a different webpage and have tags associated therewith. Three of the ad units have a “sports” tag, three have an “automobiles” tag, and the remaining four have a “dolls” tag. Each of the ad units has other additional tags, but only the above tags are used for this discussion. A publisher, wishing to determine which ad units are earning the greatest income may select the “sports” tag at a reporting page of a user interface provided by the ad network. The ad network provides the performance data elements for the three ad units having the “sports” tag. The performance data elements may be provided as a list, in tables, charts, graphs, or in any other presentation form. Alternatively, or in addition the publisher may wish to view performance data elements for ad units that may commonly appeal to men. Therefore, the publisher may select both the “sports” tag and the “automobiles” tag to have the ad network report based on those tags. Thus, the ad network is able to generate reports of ad unit performance data elements based on the ad unit tags, and thereby provide a publisher with valuable, dynamic, and customizable reporting on their ad units.

In another embodiment, a publisher has articles posted on a blog provider's website. A single ad unit is assigned to all of the publishers posts. Thus, each article is presented with the same ad unit when viewed by a user. Thus, associating tags to the ad unit and reporting performance data elements based thereon may not provide meaningful reporting. In this instance, reporting based on ad unit tags would provide data for all of the articles to which the ad unit is assigned as a group. Therefore, the publisher would not be able to differentiate performance of the ad unit with respect to one or more of the articles from the group of articles. For example, the ad unit might perform better when presented with an article on sports than it would when presented with articles on world economics. The capability to differentiate may be desirable to the publisher to enable the publisher to identify articles, topics, or writing styles that attract readers and generate the greatest advertisement revenue.

Each article has one or more tags associated with the article and listed as a comma-separated list at the end of each article. The tags are extracted and received by the ad network generally concurrently with the ad network receiving a request for advertisements to fill the ad unit on the corresponding webpage. In embodiments, the tags are extracted by programs such as plug-ins or add-on software at a publisher's computing device, or by programs at another computing device such as at the ad network or at a server hosting the webpage. In another embodiment, the tags are determined by a user's computing device executing script, or code provided with the ad unit when displaying the ad unit at the user's computing device. The publisher may access a reporting page of a user interface provided by the ad network to generate ad unit performance data reports. The publisher selects one or more tags on which to report. For example, assuming the publisher's articles are written on sports, automobiles, and pets, and assuming that the articles are tagged “sports,” “automobiles,” and “pets” respectively, then the publisher can generate reports based on each of the three tags to determine which topic is generating the greatest advertisement revenue.

In other embodiments, advertisers have access to the one or more tags. Advertisers have agreements, contracts, or free access to the tag information via the ad network or a publisher. Advertisers utilize the tags to target advertisements to ad units that may provide greater interest in the advertisement based on the tag information. Such information may have value to an advertiser for which the advertiser might be willing to pay a higher advertising rate. An advertiser may be willing to pay for access to the tag information as well as increased rates for ad units having certain tags. For example, an advertiser advertising sports equipment will pay for access to tag information for ad units and is willing to pay a publisher an increased rate for advertising in ad units tagged “sports,” “baseball,” or other sports terms.

In yet another embodiment, a publisher employs one or more tags as filters for advertising content that may be placed in an ad unit. The publisher creates an ad unit at an ad network. The ad network allows the publisher to associate tags with the ad unit and provides the publisher with the capability to designate one or more filter tags. The filter tags are used by the ad network to instruct the selection of advertisements for placement in the ad unit when a request for such an advertisement is received. For example, a publisher creating an ad unit on a webpage viewed by children might wish to restrict advertisements having adult content. The publisher thus, designates filter tags such as “adult content,” “gambling,” and “drugs.” In embodiments, advertisements are also provided with tags, or descriptions that are useable by the ad network for filtering and determining proper placement of advertisements in ad units. Thus, when the ad network receives requests to provide advertisements for the ad unit, any advertisements having similar tags or content pertaining to similar subjects may be restricted from placement at the ad unit.

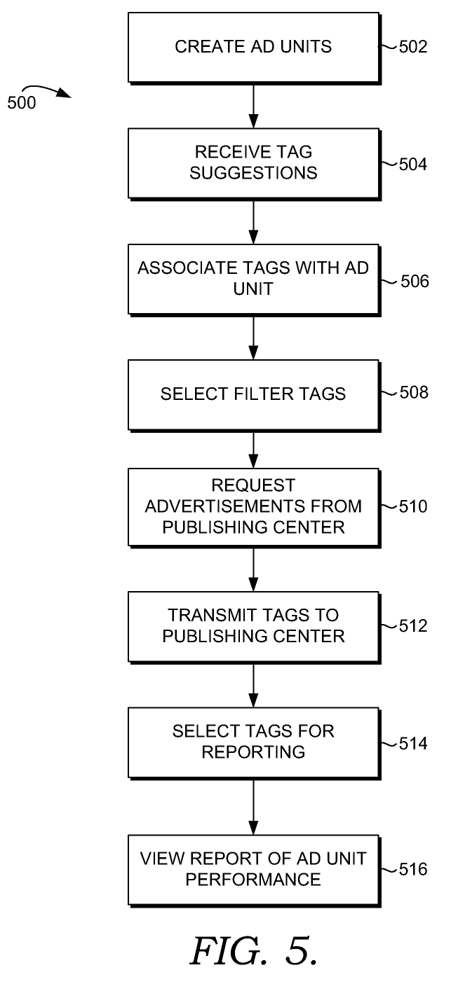

With reference now to FIG. 5, a flow diagram is provided illustrating a computer implemented method 500 for tracking ad unit performance according to embodiments of the invention. One or more ad units are created by a publisher at an ad network, as indicated at block 502. The publisher automatically receives tag suggestions from the ad network based on information that the publisher inputs with respect to the ad unit, as indicated at block 504. As indicated at block 506, the publisher associates one or more of the suggested tags and tags created by the publisher with the ad unit by inserting code segments into the webpage script. The code segments are descriptive of the tags and indicate functions necessary for transmitting the tags to the ad network. Further, the code segments may be provided by the ad network, and may also provide descriptions and indicate functions necessary for operations of the ad unit. An option to select filter tags is provided to the publisher and any desired filter tags are selected by the publisher, as indicated at block 508. A user navigates to the webpage via a web browser, and upon loading of the webpage, a request is placed with the ad network to provide advertisements for the ad unit, as indicated at block 510. Tags associated with the ad unit are also transmitted to the ad network, as indicated at block 512. The publisher returns to the ad network to view reports of performance data elements for the one or more ad units and selects one or more tags on which the ad network is to report, as indicated at block 514. The publisher may then view one or more reports generated by the ad network, as indicated at block 516.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

Having thus described the invention, what is claimed is:

1. One or more computer storage media having instructions embodied thereon that when executed by a computing device, perform a method for tracking ad unit performance, the method comprising:
receiving a request for an advertisement to be presented in association with an ad unit, wherein the ad unit comprises a location on a webpage configured for presenting advertisements;
receiving one or more tags associated with the advertisement request;
determining one or more appropriate advertisements for presentation; and
providing the determined one or more appropriate advertisements.

2. The one or more computer storage media of claim 1, further comprising recording performance of the ad unit based on the one or more tags utilizing one or more performance data elements.

3. The one or more computer storage media of claim 2, wherein each of the one or more performance data elements comprises a click-through-rate, income generated by the ad unit, visitor data, a number of impressions, and an expected cost per thousand impressions (eCPM).

4. The one or more computer storage media of claim 3, further comprising generating a report on the ad unit performance utilizing the one or more performance data elements, wherein the generated report includes performance information pertaining to the one or more tags.

5. The one or more computer storage media of claim 1, further comprising providing a suggestion for at least one additional tag to be associated with the advertisement request.

6. The one or more computer storage media of claim 1, wherein at least one of the one or more tags is a content tag extracted from a content item to be presented in association with the one or more appropriate advertisements.

7. The one or more computer storage media of claim 1, further comprising filtering at least one of the one or more appropriate advertisements based upon at least one of the one or more tags.

8. The one or more computer storage media of claim 1, further comprising targeting at least one of the one or more appropriate advertisements based upon at least one of the one or more tags.

9. A method for tracking ad unit performance utilizing a computing device, the method comprising:
associating one or more tags with an ad unit utilizing the computing device, wherein the ad unit comprises a location on a webpage for presenting advertisements;
transmitting a request for an advertisement to be presented in association with the ad unit, wherein the request includes an identifier for each of the one or more tags; and
presenting a returned advertisement in association with the ad unit on a display device coupled with the computing device.

10. The method of claim 9, further comprising selectively querying for one or more performance data elements for the ad unit based on at least one of the one or more tags associated therewith.

11. The method of claim 10, wherein each of the one or more performance data elements comprises a click-through-rate, income generated by the ad unit, visitor data, a number of impressions, and an expected cost per thousand impressions (eCPM).

12. The method of claim 11, further comprising receiving a report on performance of the ad unit in view of the queried one or more performance data elements and the one or more tags associated with the ad unit.

13. The method of claim 9, wherein associating the one or more tags with the ad unit comprises associating the one or more tags with the ad unit during creation of the ad unit.

14. The method of claim 9, wherein associating the one or more tags with the ad unit further comprises receiving a suggestion for at least one of the one or more tags.

15. The method of claim 9, further comprising:
receiving at least one content item to be presented on the web page,
wherein associating one or more tags with the ad unit comprises extracting a content tag from the at least one content item, and associating the content tag with the ad unit.

16. The method of claim 9, wherein associating the one or more tags with the ad unit comprises inserting one or more code statements associated with at least one of the one or more tags into web page script associated with the web page.

17. The method of claim 9, wherein the returned advertisement has been filtered based upon at least one of the one or more tags.

18. The method of claim 17, wherein the returned advertisement has been targeted based upon at least one of the one or more tags.

19. One or more computer storage media having instructions embodied thereon, that when executed by a computing device, perform a method for reporting ad unit performance comprising:
receiving a request for an advertisement from a webpage having an ad unit associated therewith, wherein the ad unit comprises a location on the webpage for presenting an advertisement;
receiving one or more tags associated with the received request;
providing an appropriate advertisement to be presented in association with the ad unit on the associated webpage;
recording performance of the ad unit based upon one or more performance data elements and the one or more tags associated with the received request;
receiving a selection of at least one of the one or more tags on which to report on performance utilizing the one or more performance data elements;
compiling data related to the selected at least one tag and the one or more performance data elements; and
presenting a report of the ad unit performance based upon the selected at least one tag and the one or more performance data elements.

20. The one or more computer storage media of claim 19, further comprising:
extracting at least one content tag from a content item associated with the web page; and
associating the extracted content tag with the received request.
